(19) United States
(12) Patent Application Publication
(10) Pub. No.: US 2011/0213089 A1
(43) Pub. Date: Sep. 1, 2011

(54) MOLDED TRANSPARENT RESIN AND PROCESS FOR PRODUCING THE SAME

(76) Inventors: Satoshi Yamasaki, Osaka (JP); Hiroshi Hayami, Osaka (JP); Makoto Nakabayashi, Osaka (JP)

(21) Appl. No.: 13/126,984

(22) PCT Filed: Aug. 2, 2010
(86) PCT No.: PCT/JP2010/063017

§ 371 Date: Apr. 29, 2011

(30) Foreign Application Priority Data
Aug. 31, 2009 (JP) 2009-200324

(51) Int. Cl. C08F 214/28; B29C 35/10; C08F 8/00

(52) U.S. Cl. 525/276; 264/488; 526/254

(57) ABSTRACT

The present invention provides a clear resin molded body which has high heat resistance that can be used in the reflow soldering process using Pb-free solder, which has high transparency that can be used for an optical member, and which can be easily produced, and also provides a method of producing the same.

A clear resin molded body includes a molded body of a resin composition composed of a carbon-hydrogen-bond-containing fluororesin, in which the resin composition is crosslinked by irradiating the molded body with ionizing radiation at least once in an atmosphere at a temperature lower than the melting point of the fluororesin and at least once in an atmosphere at a temperature equal to or higher than the melting point of the fluororesin. A method produces the clear resin molded body.

### TECHNICAL FIELD

The present invention relates to a clear resin molded body which is heat-resistant and suitably used as an optical member for electronic device components, and to a method of producing the same.

### BACKGROUND ART

In cellular phones, laptops, digital cameras, liquid crystal televisions, and the like, various optical films are used as optical waveguides, optical diffusion sheets, light-focusing sheets, and the like. Furthermore, various optical lenses are used as pick-up lenses, camera lenses, microarray lenses, projector lenses, Fresnel lenses, and the like. In order to produce inexpensive optical members, such as optical films and optical lenses, replacement of such films and lenses with optical members composed of a thermoplastic resin, which can be easily mass-produced, is underway. As the thermoplastic resin, an acrylate resin, polycarbonate, or the like has been widely used.

Meanwhile, in recent years, in order to cope with miniaturization and enhancement of performance of various electronic devices, the size of electronic components to be mounted has been increasingly reduced. Accordingly, as the method of mounting electronic components onto a circuit board, reflow soldering, which is a process with which a high packaging density and high production efficiency can be obtained, has been commonly used. Furthermore, in view of environmental problems, use of Pb-free solder has been desired also in the reflow soldering process.

With such a recent trend, the optical members are also desired to have such a heat resistance that they do not melt and can retain their shape even at the reflow temperature (260° C.) of Pb-free solder so that the optical members can be mounted by the reflow soldering process using Pb-free solder. However, in optical members composed of a general-purpose thermoplastic resin, it is difficult to achieve such a heat resistance. Under these circumstances, there have been demands for development of a clear resin molded body which has transparency that can be used for optical members and which has high heat resistance, and various proposals have been made.

### CITATION LIST

### Patent Literature

PTL 1: Japanese Unexamined Patent Application Publication No. 2005-171051

PTL 2: Japanese Unexamined Patent Application Publication No. 2008-231403

### SUMMARY OF INVENTION

### Technical Problem

For example, as a resin for forming a clear resin molded body having excellent heat resistance, PTL 1 discloses an aromatic polycarbonate resin including an aromatic dihydroxy component and having improved heat resistance, and it is described that the resin is used for an optical member capable of being subjected to reflow soldering. However, the glass transition temperatures of the aromatic polycarbonate resins described in examples are all 200° C. or lower. Consequently, in order to produce a material that can withstand the reflow soldering process at 260° C. or higher, it is necessary to considerably increase the amount of a special monomer. In this case, problems may arise, such as difficulty in polymerization, and a substantial increase in cost.

Furthermore, PTL2 discloses a sealant and a camera lens composed of a two-part type heat-resistant clear resin molded article (molded body), in which high heat resistance is exhibited, and, for example, the transmissivity does not decrease when exposed to an atmosphere of 200° C. for 200 hours. However, in examples, the curing time takes one hour, the firing time takes 3 hours, and so on. Thus, the molding time is very long, which makes mass production difficult.

As described above, there has not been known a clear resin molded body which has high transparency that can be used for an optical member, such as an optical film or an optical lens, which has heat resistance that can be used in the reflow soldering process using Pb-free solder, and for which there is high productivity, thus facilitating mass production. Therefore, it has been desired to develop a clear resin molded body having all of these characteristics.

It is an object of the present invention to provide a clear resin molded body which has high heat resistance that can be used in the reflow soldering process using Pb-free solder, which has high transparency that can be used for an optical member, and which can be easily produced, and to provide a method of producing the same.

### Solution to Problem

As a result of diligent research on the problems described above, the present inventor has found that it is possible to obtain a clear resin molded body having high heat resistance, high transparency, and for which there is excellent productivity by irradiating a molded body of a resin composition composed of a carbon-hydrogen-bond-containing fluororesin with ionizing radiation at least once in an atmosphere at a temperature lower than the melting point of the fluororesin and at least once in an atmosphere at a temperature equal to or higher than the melting point of the fluororesin so that the resin is crosslinked. Thus, the present invention has been completed.

That is, the present invention (a first invention of the present application) provides a clear resin molded body including a molded body of a resin composition composed of a carbon-hydrogen-bond-containing fluororesin, in which the resin composition is crosslinked by irradiating the molded body with ionizing radiation at least once in an atmosphere at a temperature lower than the melting point of the fluororesin and at least once in an atmosphere at a temperature equal to or higher than the melting point of the fluororesin.

The fluororesin constituting the resin composition is not particularly limited as long as it is a thermoplastic resin having carbon-hydrogen bonds and containing fluorine, can be formed into a clear molded body, and can be crosslinked by irradiation with ionizing radiation. Since the fluororesin is a thermoplastic resin, a molded body for forming an optical member can be easily produced with high productivity by the molding method which will be described later.

Specific examples of the carbon-hydrogen-bond-containing fluororesin include ethylene-tetrafluoroethylene copolymers, polyvinylidene fluoride, polyvinyl fluoride, ethylene-tetrafluoroethylene-hexafluoropropylene terpolymers, and the like.

Furthermore, examples of the carbon-hydrogen-bond-containing fluororesin also include copolymers between ethylene and tetrafluoroethylene or a perfluoro ethylenically unsaturated compound represented by the formula (I): CF₂═CF-Rf¹ (wherein Rf¹ represents —CF₃ or —ORf², and Rf² represents a perfluoroalkyl group having 1 to 5 carbon atoms). In these copolymers, the transparency, melting point, and crosslinking characteristic may be varied by changing the percentage of the components. More preferably, the transmissivity of the molded body before irradiation of ionizing radiation is 20% or more in the wavelength of 400 nm.

As the fluororesin used in the present invention, a fluororesin having a reactive functional group at the end of main chain and/or the end of side chain may be used. Examples of the reactive functional group include a carbonyl group, a carbonyl group-containing group such as a carbonyldioxy group or a haloformyl group, a hydroxyl group, and an epoxy group.

As the fluororesin used in the present invention, a fluororesin copolymerized with another component or a fluororesin in which another component is graft-polymerized into its ethylene moiety, in the range that does not impair the advantageous effects of the present invention, may also be used. As such a fluororesin, a commercially available product can be used, and examples thereof include Neoflon RP-4020 (trade name) manufactured by Daikin Industries, Ltd.

Furthermore, the resin composition constituting the molded body is composed of the fluororesin, and as the resin composition, a polymer alloy obtained by adding another resin component to the fluororesin, in the range that does not impair the advantageous effects of the present invention, may also be used. Examples of the other resin component include polyethylene, polypropylene, polystyrene, engineering plastics, super engineering plastics, thermoplastic elastomers, fluororesins which do not have carbon-hydrogen bonds, and copolymers of these resins.

The resin composition may contain an additive having a molecular weight of 1000 or less and having at least two carbon-carbon double bonds in its molecule in an amount of 0.05 to 20 parts by weight relative to 100 parts by weight of the fluororesin (a second invention of the present application).

In order to improve efficiency of crosslinking by irradiation of ionizing radiation, a multifunctional monomer having a molecular weight of 1000 or less and having at least two carbon-carbon double bonds in its molecule is preferably added to the resin composition composed of the fluororesin, and the amount of the multifunctional monomer to be added is preferably 0.05 to 20 parts by weight relative to 100 parts by weight of the fluororesin.

Even in the case where the amount of the multifunctional monomer (additive) added is less than 0.05 parts by weight, crosslinking is caused by irradiation of ionizing radiation, and the heat resistance intended in the present invention can be obtained. However, crosslinking efficiency is slightly low, and a large amount of irradiation dose is required. On the other hand, in the case where the amount of the additive added exceeds 20 parts by weight, there may occur problems, such as difficulty in handling during mixing in the process of producing the resin composition, bleed-out of the additive from the molded article, and a decrease in transparency because of self-polymerization of the additive, which may degrade the properties. Furthermore, by setting the amount of the additive to be added in the range of 0.05 to 20 parts by weight, incorporation into the resin composition is facilitated. More preferably, the amount of the additive to be added is 1 to 15 parts by weight.

The molecular weight of the multifunctional monomer (additive) is 1000 or less, and by setting the molecular weight at 1000 or less, the advantage that a molded body having excellent heat resistance can be obtained while maintaining transparency becomes more conspicuous. Furthermore, the additive with a molecular weight of 1000 or less has a viscosity that facilitates mixing with the fluororesin, and, in many cases, the additive has low coloration, which is also desirable.

Examples of the multifunctional monomer (additive) include 1,6-hexanediol di(meth)acry late, 1,4-butanediol di(meth)acrylate, trimethylolpropane tri(meth)acrylate, ethylene oxide-modified trimethylolpropane tri(meth)acrylate, propylene oxide-modified trimethylolpropane tri(meth)acrylate, ethylene oxide-modified bisphenol A di(meth)acrylate, diethylene glycol di(meth)acrylate, dipentaerythritol hexaacrylate, dipentaerythritol monohydroxy pentaacrylate, caprolactone-modified dipentaerythritol hexaacrylate, pentaerythritol tri(meth)acrylate, pentaerythritol tetra(meth)acrylate, polyethylene glycol di(meth)acrylate, tris(acryloxyethyl)isocyanurate, tris(methacryloxyethyl)isocyanurate, 1,6-divinyl(perfluorohexane), and the like. In particular, tris(acryloxyethyl)isocyanurate, tris(methacryloxyethyl)isocyanurate, trimethylolpropane tri(meth)acrylate, 1,6-divinyl(perfluorohexane), and the like are preferably used.

As the additive described above, a commercially available multifunctional monomer can be used. However, in some cases, commercially available multifunctional monomers may contain a stabilizer or the like to such an extent that may affect the advantageous effects of the present invention. Therefore, it is preferable to carry out a simple preliminary test, before use, on the advantageous effects of the present invention to confirm that the advantageous effects of the present invention are not affected. As the additive, an additive incorporated with a stabilizer in an amount of 1,000 ppm or less is usually used. In order to prevent the advantageous effects of the present invention from being affected, the amount of the stabilizer included in the additive is preferably as small as possible.

The resin composition can be incorporated with, in addition to the components described above, various additives, such as an antioxidant, a flame-retardant, an ultraviolet absorber, a light stabilizer, a heat stabilizer, and a lubricant.

The resin composition can be produced by mixing the materials using a known mixing device, such as an open roll mill, a pressure kneader, a single screw mixer, or a twin screw mixer. It is preferable to perform melt mixing at a temperature equal to or higher than the melting point of the fluororesin (base resin) to be used.

A method of molding the resin composition prepared as described above will now be described. As the molding method for producing a clear resin molded body of the present invention, a widely used existing molding method, such as injection molding, press molding, or extrusion molding, can be employed. The melting point of the resin composition used in the present invention can be adjusted by the type of the fluororesin, for example, by the ratio of monomers constituting the fluororesin. In the case where a fluororesin having a melting point of lower than 300° C. is used, the existing molding method can be easily employed. Note that, in the case where a fluororesin having a melting point of 300° C. or higher is used, it is necessary to perform plating treatment in consideration of corrosion of the machine due to hydrogen fluoride.

During molding, the mold/molding roll surface is easily transferred to the surface of the material. When a rough surface is transferred, scattering of light is induced, which may decrease the transmissivity. Accordingly, the mold or molding roll surface of the equipment in direct contact with the molded body is preferably ground, in particular, to a surface roughness Ra of about 1.6 a.

The clear resin molded body of the present invention is characterized in that by subjecting the molded body produced as described above to irradiation of ionizing radiation (first irradiation) at least once in an atmosphere at a temperature lower than the melting point of the fluororesin constituting the molded body and to irradiation of ionizing radiation (second irradiation) at least once in an atmosphere at a temperature equal to or higher than the melting point of the fluororesin, the resin composition is crosslinked. The fluororesin constituting the resin composition, which is a material for the clear resin molded body of the present invention, is a thermoplastic resin capable of being easily formed into a molded body, and after being crosslinked by irradiation of ionizing radiation, the molded body has heat resistance that withstands the reflow soldering process using Pb-free solder in spite of the fact that the molded body is composed of the thermoplastic resin.

Examples of the ionizing radiation source include accelerated electron beams, gamma rays, X rays, α rays, ultraviolet rays, and the like. From the standpoint of industrial applicability including ease of use of radiation source, ionizing radiation transmission thickness, the crosslinking rate, and the like, use of accelerated electron beams is preferable. The voltage for accelerating electron beams may be appropriately set depending on the thickness of the molded article and the like. For example, in the case of a molded article with a thickness of about 2 mm, the acceleration voltage is selected between 100 to 10,000 kV.

As the irradiation dose of ionizing radiation increases, the degree of crosslinking of the resin composition improves, and heat resistance improves. However, in the case where the irradiation dose is excessively large, there may occur problems, such as coloration or haze of the molded body and decomposition of the resin. Consequently, usually, the irradiation dose in the first irradiation is preferably 1,000 kGy or less. In this range, it is possible to obtain the heat resistance that withstands the reflow soldering process using Pb-free solder, and the problems described above do not occur.

After a molded body of the resin composition is obtained as described above, the molded body is irradiated with ionizing radiation. Irradiation of ionizing radiation is performed at least once in an atmosphere at a temperature lower than the melting point of the fluororesin, preferably, in an atmosphere at a temperature equal to or lower than the glass transition point, and at least once in an atmosphere at a temperature equal to or higher than the melting point of the fluororesin. Crosslinking is performed by irradiation of ionizing radiation in an atmosphere at a temperature lower than the melting point of the fluororesin, and even if the molded body is heated to a temperature equal to or higher than the melting point of the fluororesin during second irradiation, melting or deformation is not observed, and the shape of the molded body is retained.

After the first irradiation, the molded body is heated to a temperature equal to or higher than the melting point of the fluororesin and the second irradiation is performed. As a result, a molded body having high transparency is obtained. In the atmosphere at a temperature equal to or higher than the melting point of the fluororesin, crystals of the fluororesin melt, and a state in which no crystals are present is brought about. Since crosslinking is produced by performing irradiation in this state, it is believed that the amount of crystals decreases and transparency of the molded body improves.

The irradiation dose at the first irradiation is preferably 50 kGy or more. When the irradiation dose is less than 50 kGy, there may be cases where the degree of crosslinking becomes insufficient and the molded body melts or deforms when heated in an atmosphere at a temperature equal to or higher than the melting point of the fluororesin for the second irradiation. Furthermore, the irradiation dose at the first irradiation is preferably 1,000 kGy or less. When the irradiation dose exceeds 1,000 kGy, even if the molded body is heated to an atmosphere at a temperature equal to or higher than the melting point of the fluororesin, crystals do not melt, and it is difficult to obtain a molded body with high transparency.

The irradiation dose at the second irradiation is preferably 50 kGy or more. Furthermore, the temperature at the second irradiation is preferably 10° C. or more higher than the melting point of the fluororesin. When the temperature at the second irradiation is close to the melting point of the fluororesin, there may be cases where crosslinking cannot be performed in a state in which crystals are melted sufficiently, the amount of crystals does not decrease sufficiently, and transparency does not improve sufficiently.

In the clear resin molded body of the present invention, the resin composition constituting the molded body is crosslinked by irradiation of ionizing radiation, and therefore, the clear resin molded body can have the heat resistance that withstands the reflow soldering process using Pb-free solder. Specifically, even if exposed to heat at 280° C. for 60 seconds, the clear resin molded body can have excellent heat resistance in which deformation, shrinkage, or a change in transmissivity (400 nm) is not observed.

Furthermore, since the resin composition constituting the molded body is crosslinked by irradiation of ionizing radiation, stability to light improves. Specifically, even if the clear resin molded body of the present invention is exposed to a white LED of 20 cd for 100 days, a high transmissivity can be maintained.

A clear resin molded body having such a high heat resistance and a clear resin molded body having such a high light stability are novel ones which cannot be obtained in the known art. Accordingly, the present invention further provides these clear resin molded bodies as a third invention of the present application and a fourth invention of the present application.

According to the third invention of the present application, a clear resin molded body includes a molded body of a resin composition composed of a carbon-hydrogen-bond-containing fluororesin, in which, at a thickness of 2 mm, the transmissivity of light with a wavelength of 400 nm is 85% or more, the shrinkage due to heating at 280° C. for 60 seconds is 3% or less in each of the longitudinal direction and the transverse direction, and the transmissivity after heating at 280° C. for 60 seconds is 85% or more.

According to the fourth invention of the present application, a clear resin molded body includes a molded body of a resin composition composed of a carbon-hydrogen-bond-containing fluororesin, in which, at a thickness of 2 mm, the transmissivity of light with a wavelength of 400 nm is 85% or more, and the transmissivity after exposure to white light of 20 cd for 2,000 hours is 85% or more.

In addition to the clear resin molded bodies, the present invention (a fifth invention of the present application) provides a method of producing a clear resin molded body including a molding step of forming a molded body of a resin composition composed of a carbon-hydrogen-bond-containing fluororesin, a first irradiation step of irradiating the molded body obtained in the molding step with ionizing radiation at least once in an atmosphere at a temperature lower than the melting point of the fluororesin to crosslink the resin composition, and a second irradiation step of irradiating the molded body with ionizing radiation at least once in an atmosphere at a temperature equal to or higher than the melting point of the fluororesin to crosslink the resin composition. In the invention of the production method, the first invention of the present application is viewed from the aspect of production method, and the clear resin molded body described above can be produced by this method. The fluororesin, the ionizing radiation, the first irradiation, and the second irradiation are defined to be the same as those described above on the first invention of the present application.

### Advantageous Effects of Invention

The clear resin molded body of the present invention is a clear resin molded body which has high heat resistance that can be used in the reflow soldering process using Pb-free solder, which has high transparency that can be used for an optical member, and which can be easily produced. The clear resin molded body can be easily produced by the method of producing a clear resin molded body according to the present invention.

### DESCRIPTION OF EMBODIMENTS

Embodiments of the present invention will now be described on the basis of Examples. It is to be understood that the present invention is not limited to Examples described herein, and various changes and modifications may be made without deviating from the purpose of the invention.

### Examples

First, production of resin composition pellets and plates for evaluation performed in Examples and Comparative Examples will be described.

[Production of Resin Composition Pellets]

Resins and additives formulated as shown in Tables I to III were subjected to melt mixing using a twin screw mixer (30 mmφ, L/D=30), in which the barrel temperature was set at 190° C. to 280° C., at a screw rotation speed of 100 rpm, and thereby resin compositions were produced. Then, using a strand cut pelletizer, resin composition pellets were formed. The barrel temperature was appropriately selected so as to be 10° C. or more higher than the melting point of the formulated resin.

[Production of Plate for Evaluation]

Injection molding, press molding, or extrusion molding was performed using the resin composition pellets obtained as described above. The resulting molded bodies (plates) were subjected to electron beam irradiation to produce plates for evaluation. (In Comparative Example 1, electron beam irradiation was not performed.) Conditions for injection molding, press molding, and extrusion molding and conditions for electron beam irradiation will be shown below.

1) Injection Molding

Resin composition pellets were placed in an injection molding machine (manufactured by Nissei Plastic Industrial Co., Ltd.) with a mold clamping force of about 40 t, and the injection molding was performed using a mold made of SUS304 ground to a surface roughness Ra of about 1.6 a. Thereby, a plate with a predetermined thickness was produced. This molding method was used when molded bodies with a thickness of 0.8 mm or more were produced.

2) Press Molding

Resin composition pellets were pressed by a hot pressing machine at a temperature 20° C. higher than the melting point for 10 minutes, at 200 N/cm², and thereby, a prepressed sheet with a thickness of 0.3 mm was produced. The prepressed sheet was fixed inside a metal frame with a predetermined thickness, and 2-mm plates (mirror plates) made of SUS304 ground to a surface roughness Ra of about 1.6 a were disposed as spacers on upper and lower sides thereof. Pressing was performed at a temperature 20° C. higher than the melting point for 10 minutes, at 40 N/cm², and thereby, a plate (film) with a predetermined thickness was produced. This molding method was used when a molded body with a thickness of less than 0.25 mm was produced.

3) Extrusion Molding

Resin composition pellets were placed in a 20-mmφ extruder (single screw type; manufactured by Toyo Machinery & Metal Co., Ltd.) and extruded through a T die at the die orifice. A smooth surface was transferred to the resulting film by a roll made of SUS304 (stainless roll with a mirror surface) having a surface ground to a surface roughness Ra of about 1.6 a, and the thickness was adjusted. Thereby, a plate with a predetermined thickness was produced. This molding method was used when a molded body with a thickness of 0.25 mm or more and less than 0.8 mm was produced.

4) Conditions for Electron Beam Irradiation

The plates produced by the molding methods described above were irradiated with accelerated electron beams with an acceleration voltage of 2,000 kV at predetermined temperatures and predetermined doses shown in Tables I to III. Specifically, in Examples, electron beam irradiation was performed in an atmosphere at a temperature lower than the melting point of the fluororesin (hereinafter referred to as “first irradiation”), at the temperature and dose described under the column “first irradiation” in Tables, then transmissivity 1 was measured by the method described below, and subsequently, electron beam irradiation was performed in an atmosphere at a temperature equal to or higher than the melting point of the fluororesin (hereinafter referred to as “second irradiation”), at the temperature and dose described under the column “second irradiation” in Tables. In Comparative Example 3, electron beam irradiation was not performed in an atmosphere at a temperature lower than the melting point of the fluororesin. However, even in this case, electron beam irradiation in an atmosphere at a temperature equal to or higher than the melting point of the fluororesin is considered as the “second irradiation”. Temperature control was performed with a thermostatic oven provided in the irradiation device. Although it may be possible to perform temperature control using a hot plate type temperature-controlling device in which heat is applied from one side of the molded body, a thermostatic oven type which can heat all the atmosphere around the molded body is more preferable.

In Example 2, after the first irradiation, the second irradiation was continuously performed without measuring transmissivity 1. In Comparative Example 1, neither the first irradiation nor the second irradiation was performed. In other comparative examples, the first irradiation and/or the second irradiation was performed under the conditions described in Tables II and III. In Comparative Examples 2 and 5, the second irradiation was not performed, and in Comparative Example 3, the first irradiation was not performed.

[Evaluation Method]

The method for evaluating the plates for evaluation obtained as described above will now be described.

(1) Transmissivity 1

Transmissivity from the ultraviolet region 200 nm to the near-infrared region 1,000 nm was measured on a 10 mm×10 mm square sample cut out from a plate taken after completion of the first irradiation, and it was confirmed that the waveform was continuous. The transmissivity at 400 nm obtained by the measurement was defined as transmissivity 1, which is shown in Tables I to III. In Comparative Example 1 in which electron beam irradiation was not performed and in Comparative Example 3 in which the first irradiation was not performed, the transmissivity was measured on the plate obtained by molding and defined as transmissivity 1.

(2) Measurement of Initial Basic Properties

1) Transmissivity 2 and transmissivity 3 (transmissivity after electron beam irradiation in an atmosphere at a temperature equal to or higher than the melting point of the fluororesin)

A 10 mm×10 mm square sample was cut out from the plate subjected to the second electron beam irradiation by the method described above. Transmissivity from the ultraviolet region 200 nm to the near-infrared region 1,000 nm was measured on the resulting sample, and it was confirmed that the waveform was continuous. The transmissivity at 400 nm obtained by the measurement was defined as transmissivity 2, and the transmissivity at 850 nm was defined as transmissivity 3, which are shown in Tables I to III. In Comparative Example 1, the measurement was performed on the molded plate not subjected to electron beam irradiation, and in Comparative Example 2, the measurement was performed on the plate subjected to the first electron beam irradiation. In each of Comparative Examples 1 and 2, the measured values at 400 nm and 850 nm were defined as transmissivity 2 and transmissivity 3, respectively (namely, in this case, transmissivity 1=transmissivity 2).

2) Color/Shape

The color/shape of the plates after being subjected to the second irradiation (electron beam irradiation in an atmosphere at a temperature equal to or higher than the melting point of the fluororesin) were visually checked, and the results thereof are shown under the column “color/shape” in Tables I to III. The plates after being subjected to irradiation which have no problems, such as coloration, haze, deformation due to melting, and inability of shape retention because of decomposition due to irradiation, are evaluated to be “good”.

(3) Evaluation of Heat Resistance

1) Color/Shape after Heating

The plates after being subjected to the second irradiation (electron beam irradiation in an atmosphere at a temperature equal to or higher than the melting point of the fluororesin) were cut into a size of 30 mm×30 mm square. The resulting samples were left to stand and heated in a thermostatic oven at 280° C. for 60 seconds, and then the color/shape of the plates were visually checked. The results thereof are shown under the column “color/shape after heating” in Tables I to III. The plates which have no problems, such as softening due to heating, deformation due to melting, wrinkling, coloration, and haze, are evaluated to be “retained” under the column “color/shape after heating”. Regarding deformation due to melting, a plate with the side of which has shrunk to a size of 29.9 mm or less when measured with micrometer calipers is considered to be deformed.

This measurement was performed on the plate not subjected to electron beam irradiation in Comparative Example 1, on the plate subjected to the first irradiation in Comparative Example 2, and on the plate subjected to annealing after the first irradiation in Comparative Example 5.

2) Transmissivity 4 and Transmissivity 5 (Transmissivity after Heating)

A 10 mm×10 mm square sample was cut out from the plate heated in the thermostatic oven by the method described above. Transmissivity from the ultraviolet region 200 nm to the near-infrared region 1,000 nm was measured on the resulting sample, and it was confirmed that the waveform was continuous. The transmissivity at 400 nm obtained by the measurement was defined as transmissivity 4, and the transmissivity at 850 nm was defined as transmissivity 5, which are shown in Tables I to III.

(4) Evaluation of Light Stability

1) Color/Shape after Exposure to Light

A 10 mm×10 mm square sample was cut out from the plate subjected to the second irradiation (electron beam irradiation in an atmosphere at a temperature equal to or higher than the melting point of the fluororesin). The resulting sample was placed at a position 5 mm from the light source of white LED “CLE-24” (center luminosity 20 cd) manufactured by PATLITE Corporation, and exposure to light was performed for 100 days. The color/shape after the exposure to light were visually checked. The results thereof are shown under the column “color/shape after exposure to light” in Tables I to III. The plates which have no problems, such as deformation due to exposure to light, wrinkling, coloration, and haze, are evaluated to be “retained” under the column “color/shape after exposure to light”.

This measurement was performed on the plate not subjected to electron beam irradiation in Comparative Example 1, on the plate subjected to the first irradiation in Comparative Example 2, and on the plate subjected to annealing after the first irradiation in Comparative Example 5.

2) Transmissivity 6 and Transmissivity 7 (Transmissivity after Exposure to Light)

After the exposure to light, in the same manner as that described above, transmissivity from the ultraviolet region 200 nm to the near-infrared region 1,000 nm was measured, and it was confirmed that the waveform was continuous. The transmissivity at 400 nm obtained by the measurement was defined as transmissivity 6, and the transmissivity at 850 nm was defined as transmissivity 7, which are shown in Tables I to III.

The materials used in the production of resin composition pellets in Examples and Comparative Examples will be described below.

[Resin]

1) Ethylene-tetrafluoroethylene-hexafluoropropylene copolymer (hereinafter referred to as “EFEP”): specific gravity 1.72 to 1.76, melting point 155° C. to 170° C.

2) Ethylene-tetrafluoroethylene copolymer (hereinafter referred to as “ETFE”): specific gravity 1.73 to 1.87, melting point 225° C. to 265° C.

3) Tetrafluoroethylene-hexafluoropropylene copolymer (hereinafter referred to as “FEP”): specific gravity 2.15, melting point 255 to 270

4) Polycarbonate (hereinafter referred to as “PC”): “Iupilon S3000” manufactured by Mitsubishi Engineering-Plastics Corporation

[Additive (Crosslinking Auxiliary)]

1) Triallyl isocyanurate (with 50 ppm of MEHQ added) (expressed as “additive 1” in Tables I to III)

2) Ttrimethylolpropane trimethacrylate (with 50 ppm of MEHQ added) (expressed as “additive 2” in Tables I to III)

### Example 1

Using a fluororesin EFEP (melting point 155° C. to 170° C.) as a resin, without using an additive (crosslinking auxiliary), resin composition pellets were produced, and injection molding was performed. A plate for evaluation was produced by performing the first irradiation and the second irradiation under the conditions shown in Table I. The evaluation described above was performed using the plate for evaluation. The followings are evident from the evaluation results shown in Table I.
The results are “good” under the column “color/shape” in Table I, and no deformation due to heating at 280° C. is observed.
Although transmissivity 1 is low at 74%, transmissivity 2 exceeds 90%. Furthermore, transmissivity 4 after heating at 280° C. for 60 seconds and transmissivity 6 after exposure to white LED for 100 days are high at 85% or more. As is evident from the results, the sample after the second irradiation (product of the present invention) has high transparency, excellent heat resistance, and stability to light.

### Example 2

As in Example 1, without using an additive (crosslinking auxiliary), resin composition pellets were produced, and injection molding was performed. A plate for evaluation was produced by performing the first irradiation and the second irradiation under the conditions shown in Table I. The evaluation described above was performed using the plate for evaluation. However, unlike Example 1, the first irradiation and the second irradiation were continuously performed (as a result, measurement of transmissivity 1 was not possible). Furthermore, the first irradiation dose was increased from that in Example 1, while the second irradiation dose was decreased from that in Example 1. The followings are evident from the evaluation results shown in Table I.
The results are “good” under the column “color/shape” in Table I, and no deformation due to heating at 280° C. is observed.
Transmissivity 2 exceeds 90%. Furthermore, transmissivity 4 after heating at 280° C. for 60 seconds and transmissivity 6 after exposure to white LED for 100 days are high at 85% or more. As is evident from the results, the sample after the second irradiation (product of the present invention) has high transparency, excellent heat resistance, and stability to light.

### Examples 3 to 8

By using a fluororesin EFEP as a resin and adding an additive (crosslinking auxiliary) in the amount shown in Table I or II, resin composition pellets were produced, and molding was performed. Plates for evaluation were produced by performing the first irradiation and the second irradiation under the conditions shown in Table I. The evaluation described above was performed using the plates for evaluation. The electron beam irradiation dose for the first irradiation was the same as that in Example 1 (lower than that in Example 2). The electron beam irradiation dose for the second irradiation was the same as that in Example 2 (lower than that in Example 1).

In Example 4, the thickness of the molded article was set at 0.15 mm. In Example 5, the thickness of the molded article was set at 8 mm. In Examples 3, 6, and 7, the thickness of the molded article was the same as that in Examples 1 and 2 at 2 mm. In Example 8, the thickness of the molded article was set at 0.5 mm. Consequently, molding was performed by press molding in Example 4, by injection molding in Examples 3, 5, 6, and 7, and by extrusion molding in Example 8. In Example 6, production was performed under the same conditions as those in Example 3 except that the amount of additive 1 was increased. In Example 7, production was performed under the same conditions as those in Example 3 except that additive 2 was used instead of additive 1. The followings are evident from the evaluation results shown in Tables I and II.
The results are “good” under the column “color/shape” in Tables I and II, and no deformation due to heating at 280° C. is observed.
Although transmissivity 1 is low at 75% or less in many examples, transmissivity 2 is 85% or more in all examples in spite of differences in the amount and type of additive and the difference in the plate thickness. Furthermore, transmissivity 4 after heating at 280° C. for 60 seconds and transmissivity 6 after exposure to white LED for 100 days are high at 85% or more in spite of the difference in the plate thickness. The results confirm high transparency, excellent heat resistance, and stability to light. It is also evident from comparison between the results of Examples 1 and 2 and the results of Examples 3 and 7 that by adding a multifunctional monomer as an additive (crosslinking auxiliary), the dose during irradiation can be decreased.

### Example 9

A plate for evaluation was produced as in Example 3 except that a fluororesin ETFE (melting point 265° C.) was used as a resin, and the second irradiation temperature was set at 300° C. The evaluation described above was performed using the plate for evaluation. The evaluation results are shown in Table II.

As shown in Table II, transmissivity 2, transmissivity 4 after heating at 280° C. for 60 seconds, and transmissivity 6 after exposure to white LED for 100 days are 85% or more. The results confirm high transparency, excellent heat resistance, and stability to light even in the case where the resin was changed to ETFE.

### Comparative Example 1

A plate for evaluation was produced as in Example 1 except that neither the first irradiation nor the second irradiation was performed. The evaluation described above was performed using the plate for evaluation. The evaluation results are shown in Table II. Transmissivity 1 (=transmissivity 2) is low at 75%, and haze is visually observed. Thus, it is considered that use of the plate as a clear member is difficult.

Furthermore, melting is observed after heating at 280° C. for 60 seconds, and heat resistance is insufficient. Thus, it is considered that the plate cannot withstand the reflow process using Pb-free solder. Furthermore, transmissivity 6 and transmissivity 7 after exposure to white LED for 100 days decrease from transmissivity 2 and transmissivity 3 before exposure, respectively. Thus, it is considered that stability to light is insufficient.

### Comparative Example 2

A plate for evaluation was produced as in Example 3 except that only the first irradiation was performed and the second irradiation was not performed. The evaluation described above was performed using the plate for evaluation. The evaluation results are shown in Table II. Transmissivity 1 (=transmissivity 2) is low at 68%, and haze is visually observed. Thus, it is considered that use of the plate as a clear member is difficult.

Melting is not observed after heating at 280° C. for 60 seconds, and the shape of the plate is retained. However, transmissivity 4 and transmissivity 5 after heating decrease from transmissivity 2 and transmissivity 3 before exposure, respectively. Furthermore, transmissivity 2 is low at 68%, indicating low transparency, and haze is visually observed. Although the plate has heat resistance that withstands the reflow soldering process, it is considered that use of the plate as a clear member is difficult and that the plate has insufficient color retention.

### Comparative Example 3

A plate for evaluation was produced as in Example 3 except that the first irradiation was not performed, and the second irradiation only was performed after measurement of transmissivity 1. Since irradiation was not performed in an atmosphere at a temperature lower than the melting point of the fluororesin, crosslinking was not caused in this stage. Therefore, when the atmosphere at a temperature equal to or higher than the melting point was brought about, melting occurred. Since electron beam irradiation was performed in the melted state to cause crosslinking, the shape of the molded body was not retained. Consequently, measurement of transmissivity 2 and transmissivity 3, evaluation of heat resistance, and evaluation of light stability were not possible.

### Comparative Example 4

A plate for evaluation was produced as in Example 1 (first irradiation dose 100 kGy) except that the first irradiation dose was set at 1,500 kGy. The evaluation described above was performed using the plate for evaluation. The evaluation results are shown in Table III.

Melting is not observed after heating at 280° C. for 60 seconds, and the shape of the plate is retained. Thus, it is considered that the plate has heat resistance that withstands the reflow soldering process using Pb-free solder. However, although electron beam irradiation is performed in an atmosphere at a temperature equal to or higher than the melting point of the fluororesin, improvement from transmissivity 1 to transmissivity 2 is small. Furthermore, transmissivity 2 is low at 70%, indicating low transparency, and haze is visually observed. Thus, it is considered that use of the plate as a clear member is difficult. The reason for the haze is believed to be that the first irradiation dose is 1,500 kGy, which is larger than 1,000 kGy.

### Comparative Example 5

A plate for evaluation was produced as in Example 3 except that the second irradiation was not performed, and after the first irradiation was performed and transmissivity 1 was measured, annealing treatment was performed in an atmosphere at a temperature of 220° C. which was higher than the melting point. The evaluation described above was performed using the plate for evaluation. The evaluation results are shown in Table III.

Melting is not observed even after heating at 280° C. for 60 seconds, and the shape of the plate is retained. Thus, it is considered that the plate has heat resistance that withstands the reflow soldering process using Pb-free solder. However, improvement from transmissivity 1 to transmissivity 2 is small, and transmissivity 2 is low at 70%, indicating low transparency. Haze is visually observed. Thus, it is considered that use of the plate as a clear member is difficult. The results confirm that it is necessary to perform electron beam irradiation in an atmosphere at a temperature equal to or higher than the melting point of the fluororesin.

### Comparative Example 6

A plate for evaluation was produced as in Example 3 except that, as a resin, FEP (melting point 255° C.) not having carbon-hydrogen bonds was used instead of EFEP, and the second irradiation temperature was set at 300° C. The evaluation described above was performed using the plate for evaluation. The evaluation results are shown in Table III. The electron beam irradiation promoted decomposition rather than crosslinking, and the molded body became brittle, resulting in difficulty in retaining shape (expressed as “brittle” under the column “color/shape” in Table III). As is evident from the results, FEP which does not have carbon-hydrogen bonds, although being a fluororesin, cannot be used.

### Comparative Example 7

A plate for evaluation was produced as in Example 3 except that, as a resin, general-purpose PC was used instead of EFEP, and the second irradiation temperature was set at 250° C. (equal to or higher than the softening point of PC). The evaluation described above was performed using the plate for evaluation. The evaluation results are shown in Table III. Coloration to green due to irradiation is observed, and it is considered that use of the plate as a clear member is difficult. Furthermore, because of insufficient crosslinking, melting is observed during the second irradiation. As is evident from the results, the advantageous effects of the present invention are not obtained by general-purpose PC.

TABLE I

| | | | Examples | | | | |
|---|---|---|---|---|---|---|---|
| No. | | | 1 | 2 | 3 | 4 | 5 |
| Composition | | EFEP | 100 | 100 | 100 | 100 | 100 |
| (parts by weight) | | ETFE | — | — | — | — | — |
| | | FEP | — | — | — | — | — |
| | | PC | — | — | — | — | — |
| | | Additive 1 | — | — | 2 | 2 | 2 |
| | | Additive 2 | — | — | — | — | — |
| First irradiation | Temperature | ° C. | 25 | 25 | 25 | 25 | 25 |
| | Dose | kGy | 100 | 200 | 100 | 100 | 100 |
| Transmissivity 1 | | % | 74 | 73 | 95 | 68 | |
| Second irradiation | Temperature | ° C. | 220 | 220 | 220 | 220 | 220 |
| | Dose | kGy | 200 | 100 | 100 | 100 | 100 |

| | | | | | | |
|---|---|---|---|---|---|---|
| Thickness of molded article | mm | 2 | 2 | 2 | 0.15 | 8 |
| Transmissivity 2 | % | 93 | 93 | 92 | 95 | 88 |
| Transmissivity 3 | % | 94 | 94 | 94 | 96 | 91 |

| | | | | | |
|---|---|---|---|---|---|
| Hue/shape | Good | Good | Good | Good | Good |

Evaluation of heat resistance

| | | | | | | |
|---|---|---|---|---|---|---|
| Transmissivity 4 | % | 91 | 91 | 90 | 94 | 88 |
| Transmissivity 5 | % | 93 | 92 | 93 | 96 | 91 |

| | | | | | |
|---|---|---|---|---|---|
| Hue/shape after heating | Retained | Retained | Retained | Retained | Retained |

Evaluation of light stability

| | | | | | | |
|---|---|---|---|---|---|---|
| Transmissivity 6 | % | 93 | 91 | 91 | 94 | 87 |
| Transmissivity 7 | % | 93 | 92 | 92 | 96 | 90 |

| | | | | | |
|---|---|---|---|---|---|
| Hue/shape after exposure to light | Retained | Retained | Retained | Retained | Retained |

TABLE II

| | | | Examples | | | | Comparative Examples | |
|---|---|---|---|---|---|---|---|---|
| No. | | | 6 | 7 | 8 | 9 | 1 | 2 |
| Composition | | EFEP | 100 | 100 | 100 | — | 100 | 100 |
| (parts by weight) | | ETFE | — | — | — | 100 | — | — |
| | | FEP | — | — | — | — | — | — |
| | | PC | — | — | — | — | — | — |
| | | Additive 1 | 10 | | 2 | 2 | — | 2 |
| | | Additive 2 | — | 2 | — | — | — | — |
| First | Temperature | ° C. | 25 | 25 | 25 | 25 | — | 25 |
| irradiation | Dose | kGy | 100 | 100 | 100 | 100 | — | 100 |
| Transmissivity 1 | | % | 70 | 72 | 92 | 61 | 75 | 68 |
| Second | Temperature | ° C. | 220 | 220 | 220 | 300 | — | — |
| irradiation | Dose | kGy | 100 | 100 | 100 | 100 | — | — |

| | | | | | | | |
|---|---|---|---|---|---|---|---|
| Thickness of molded article | mm | 2 | 2 | 0.5 | 2 | 2 | 2 |
| Transmissivity 2 | % | 89 | 91 | 92 | 86 | 75 | 68 |
| Transmssivity 3 | % | 92 | 94 | 93 | 90 | 78 | 70 |

| | | | | | | |
|---|---|---|---|---|---|---|
| Hue/shape | Good | Good | Good | Good | Hazy | Hazy |

Evaluation of a heat resistance

| | | | | | | | |
|---|---|---|---|---|---|---|---|
| Transmissivity 4 | % | 85 | 87 | 91 | 85 | Unmeasurable | 64 |
| Transmissivity 5 | % | 91 | 93 | 93 | 90 | Unmeasurable | 65 |

| | | | | | | |
|---|---|---|---|---|---|---|
| Hue/shape after heating | Retained | Retained | Retained | Retained | Melted | Retained |

Evaluation of light stability

| | | | | | | | |
|---|---|---|---|---|---|---|---|
| Transmissivity 6 | % | 86 | 88 | 92 | 85 | 67 | 60 |
| Transimissivity 7 | % | 89 | 89 | 93 | 88 | 68 | 61 |

| | | | | | | |
|---|---|---|---|---|---|---|
| Hue'shape after exposure to light | Retained | Retained | Retained | Retained | Retained | Retained |

TABLE III

| | | | Comparative Examples | | | | |
|---|---|---|---|---|---|---|---|
| No . | | | 3 | 4 | 5 | 6 | 7 |
| Composition | | EFEP | 100 | 100 | 100 | — | — |
| (parts by weight) | | ETFE | — | — | — | — | — |
| | | FEP | — | — | — | 100 | — |
| | | PC | — | — | — | — | 100 |
| | | Additive 1 | 2 | — | 2 | 2 | 2 |
| | | Additive 2 | — | — | — | — | — |
| First | Temperature | ° C. | — | 25 | 25 | 25 | 25 |
| irridiation | Dose | kGy | — | 1500 | 100 | 100 | 100 |
| Transmissivity 1 | | % | 74 | 68 | 73 | 64 | 72 |
| Second | Temperature | ° C. | 220 | 220 | 220 | 300 | 250 |
| irradiation | Dose | kGy | 100 | 200 | | 100 | 100 |
| Thickness of molded article | | mm | — | 2 | 2 | — | — |
| Transmissivity 2 | | % | Unmeasurable | 70 | 79 | Unmeasurable | Unmeasurable |
| Transmissivity 3 | | % | Unmeasurable | 72 | 80 | Unmeasurable | Unmeasurable |
| Hue/shape | | | Largely | Hazy | Hazy | Brittle | Light green/ |
| | | | deformed | | | | melted |

Evaluation of heat resistance

| Transmissivity 4 | % | Unmeasurable | 70 | 73 | Unmeasurable | Unmeasurable |
|---|---|---|---|---|---|---|
| Transmissivity 5 | % | Unmeasurable | 71 | 75 | Unmeasurable | Unmeasurable |
| Hue/shape after heating | | Unmeasurable | Retained | Retained | Unmeasurable | Light green/ |
| | | | | | | melted |

Evaluation of light stability

| | | | | | | |
|---|---|---|---|---|---|---|
| Transmissivity 6 | % | Unmeasurable | 66 | 69 | Unmeasurable | — |
| Transmissivity 7 | % | Unmeasurable | 68 | 72 | Unmeasurable | — |

| | | | | | |
|---|---|---|---|---|---|
| Hue/shape shape after exposure to light | Unmeasurable | Retained | Retained | Unmeasurable | — |

### INDUSTRIAL APPLICABILITY

A clear resin molded body according to the present invention has high stability to heat and light and high transparency. Consequently, the clear resin molded body is suitably used as an optical member, such as an optical lens or an optical film, and because of its high heat resistance, the clear resin molded body can be mounted onto a circuit board or the like by the reflow soldering process using Pb-free solder.

1. A clear resin molded body comprising a molded body of a resin composition composed of a carbon-hydrogen-bond-containing fluororesin, wherein the resin composition is crosslinked by irradiating the molded body with ionizing radiation at least once in an atmosphere at a temperature lower than the melting point of the fluororesin and at least once in an atmosphere at a temperature equal to or higher than the melting point of the fluororesin.

2. The clear resin molded body according to claim 1, wherein the resin composition contains an additive having a molecular weight of 1000 or less and having at least two carbon-carbon double bonds in its molecule in an amount of 0.05 to 20 parts by weight relative to 100 parts by weight of the fluororesin.

3. A clear resin molded body comprising a molded body of a resin composition composed of a carbon-hydrogen-bond-containing fluororesin, wherein, at a thickness of 2 mm, the transmissivity of light with a wavelength of 400 nm is 85% or more; the shrinkage due to heating at 280° C. for 60 seconds is 3% or less in each of the longitudinal direction and the transverse direction; and the transmissivity after heating at 280° C. for 60 seconds is 85% or more.

4. A clear resin molded body comprising a molded body of a resin composition composed of a carbon-hydrogen-bond-containing fluororesin, wherein, at a thickness of 2 mm, the transmissivity of light with a wavelength of 400 nm is 85% or more; and the transmissivity after exposure to white light of 20 cd for 2,000 hours is 85% or more.

5. A method of producing a clear resin molded body comprising:
a molding step of forming a molded body of a resin composition composed of a carbon-hydrogen-bond-containing fluororesin;
a first irradiation step of irradiating the molded body obtained in the molding step with ionizing radiation at least once in an atmosphere at a temperature lower than the melting point of the fluororesin to crosslink the resin composition; and
a second irradiation step of irradiating the molded body with ionizing radiation at least once in an atmosphere at a temperature equal to or higher than the melting point of the fluororesin to crosslink the resin composition.
